(19) United States
(12) Patent Application Publication
(10) Pub. No.: US 2014/0257962 A1
(43) Pub. Date: Sep. 11, 2014

(54) DIRECTING ADVERTISEMENTS TO COMPUTING DEVICES

(71) Applicant: UMEWIN, PBC, Potomac, MD (US)

(72) Inventors: Pablo Franzetti, Potomac, MD (US); Franco Gai, Buenos Aires (AR); Pedro Morris, Buenos Aires (AR)

(73) Assignee: UMEWIN, PBC, Potomac, MD (US)

(21) Appl. No.: 14/203,979

(22) Filed: Mar. 11, 2014

Related U.S. Application Data
(60) Provisional application No. 61/776,475, filed on Mar. 11, 2013.

(51) Int. Cl. G06Q 30/02

(52) U.S. Cl. CPC G06Q 30/0231; G06Q 30/0267; G06Q 30/0261; G06Q 30/0226
USPC 705/14.31; 705/14.64; 705/14.58; 705/14.27

(57) ABSTRACT

An indication that a user has elected to receive interactive multimedia on a device is received. An interactive multimedia is selected. The selected interactive multimedia is customized and the customized interactive multimedia is provided to the device. The customized interactive multimedia causes the customized interactive multimedia to be consumed by the user. Additionally, a donation amount can be calculated to donate to a charitable cause based on revenue generated by an advertisement provided to a user. An incentive is determined for the user based on the revenue generated by the advertisement. A determination is made of whether the user donated a portion of the incentive. Upon determining that the user donated a portion of the incentive, a loyalty credit is calculated based on the portion of the incentive. The loyalty credit is associated with a loyalty program that rewards the user for a charitable action.

### RELATED APPLICATIONS

This application is related to and claims the benefit of U.S. Provisional Patent application Ser. No. 61/776,475, filed Mar. 11, 2013, which is hereby incorporated by reference in its entirety.

### TECHNICAL FIELD

Embodiments of the present disclosure relate to the field of advertising on computing devices and, more particularly, to a system and method for directing interactive multimedia to computing devices.

### BACKGROUND

Electronic advertising allows advertisers (e.g., companies, etc.) to provide interactive multimedia to users on their computing devices. Current electronic interactive multimedia may include Short Message Service (SMS) advertisements, search engine advertisements, web display advertisements, application display advertisements, etc. An SMS advertisement can be sent as a short message to a user on a mobile device of the user using standardized communication protocols. A search engine advertisement can appear as part of search results provided by a search engine rendered by a mobile application or browser on the computing device. A web display advertisement can appear as part of a display rendered by a mobile application or browser that is connected to the Internet on the computing device. An application display advertisement can appear as part of a display rendered by a mobile application on a computing device.

The current solutions are viewable by a user for only the amount of time that a user is using a mobile application or viewing an SMS. Moreover, a user does not directly benefit from the interactive multimedia.

### SUMMARY

In one embodiment, a method to direct customized interactive multimedia to computing devices is presented. An indication that a user has elected to receive interactive multimedia on a computing device associated with the user is received. An interactive multimedia is selected to provide to the user. The selected interactive multimedia is customized and the customized interactive multimedia is provided to the computing device associated with the user. The customized interactive multimedia being provided to the computing device causes the customized interactive multimedia to be consumed by the user.

A donation amount may be calculated to donate to a charitable cause based on revenue generated by an advertisement provided to a user. A user incentive is determined for the user based on the revenue generated by the advertisement provided to the user. A determination is made of whether the user donated a portion of the user incentive. Upon determining that the user donated a portion of the user incentive, a loyalty credit is calculated to provide to the user based on the portion of the user incentive donated. The loyalty credit is associated with a loyalty program that rewards the user for a charitable action.

In additional embodiments, computing devices for performing the operations of the above described embodiments are also implemented. Additionally, in embodiments of the disclosure, a computer readable storage media stores methods for performing the operations of the above described embodiments.

### BRIEF DESCRIPTION OF THE DRAWINGS

The present disclosure will be understood more fully from the detailed description given below and from the accompanying drawings of various embodiments of the disclosure.

FIG. 1 illustrates an example system architecture, in accordance with one embodiment of the present disclosure.

FIG. 2 illustrates an example system architecture, in accordance with another embodiment of the present disclosure.

FIG. 3A illustrates a user interface for providing interactive multimedia as a visual wallpaper, in accordance with one embodiment of the present disclosure.

FIG. 3B illustrates a user interface for providing interactive multimedia as a textual wallpaper, in accordance with one embodiment of the present disclosure.

FIG. 4A illustrates a user interface for providing interactive multimedia as an ringtone, in accordance with one embodiment of the present disclosure.

FIG. 4B illustrates a user interface for providing interactive multimedia as a visual promotion, in accordance with one embodiment of the present disclosure.

FIG. 4C illustrates a user interface for providing interactive multimedia as a video, in accordance with one embodiment of the present disclosure.

FIG. 5A illustrates a user interface for providing a list of charitable causes, in accordance with one embodiment of the present disclosure.

FIG. 5B illustrates a user interface to allow a user to donate to a charitable cause, in accordance with one embodiment of the present disclosure.

FIG. 5C illustrates a user interface to provide confirmation to a user of a donation made to a charitable cause, in accordance with one embodiment of the present disclosure.

FIG. 6 illustrates a flow diagram illustrating one embodiment for a method of directing interactive multimedia to computing devices, in accordance with one embodiment of the present disclosure.

FIG. 7 illustrates a flow diagram illustrating one embodiment for a method of providing an advertiser benefit, in accordance with one embodiment of the present disclosure.

FIG. 8A illustrates an exemplary push service, in accordance with one embodiment of the present disclosure.

FIG. 8B illustrates an exemplary push service, in accordance with another embodiment of the present disclosure.

FIG. 9 illustrates a block diagram of an exemplary computer system that may perform one or more of the operations described herein.

FIG. 10 illustrates a flow diagram illustrating an embodiment for a method of directing interactive multimedia to computing devices, in accordance with an alternate embodiment of the present disclosure.

### DETAILED DESCRIPTION

Embodiments of the disclosure pertain to directing customized interactive multimedia to computing devices.

With computing devices being used more and more on a daily basis, advertisers are trying to reach the users of the computing devices using the computing devices. Current electronic interactive multimedia, or advertisements, may include Short Message Service (SMS) advertisements, search engine advertisements, web display advertisements, application display advertisements, etc. An SMS advertisement can be sent as a short message to a user on a mobile device of the user using standardized communication protocols. A search engine advertisement can appear as part of search results provided by a search engine rendered by a mobile application or browser on the computing device. A web display advertisement can appear as part of a display rendered by a mobile application or browser that is connected to the Internet on the computing device. An application display advertisement can appear as part of a display rendered by a mobile application on a computing device. However, phones in particular have much less real estate for advertising, and traditional banners are even less appealing than they are on PCs due to this limitation. Accordingly, as audiences shift to mobile devices/settings, advertising cost-per-click (CPC) prices have decreased over time. Additionally, the advertiser has no knowledge of the user that is viewing the interactive multimedia, and therefore cannot customize the interactive multimedia to the specific user of the computing device. Moreover, the advertiser does not know if the user saw the interactive multimedia. In addition, neither the user nor a charitable cause may benefit from the interactive multimedia, other than possibly being exposed to the advertiser that sent the interactive multimedia (hearing of the company). The advertiser may benefit from the interactive multimedia if the user views or notices the interactive multimedia, but otherwise may not directly benefit from the interactive multimedia.

Accordingly, aspects of the present disclosure allow for directing interactive multimedia to computing devices. Examples of such interactive multimedia include, but are not limited to, visual content (e.g., visual wallpaper), textual content (e.g., a textual description), audio content (e.g., a ringtone), video content, etc. A user of a computing device can register to receive interactive multimedia. The interactive multimedia can be provided to the user on the computing device of the user such that the user is exposed to the interactive multimedia. For example, the interactive multimedia can be displayed on a wallpaper of the computing device, audibly played as a ringtone of the computing device, displayed on a screen saver, etc. The interactive multimedia can be customized for the user based on preferences and other information provided by the user (e.g., during registration).

In some embodiments, a donation amount can be calculated to be donated to a charitable cause based on revenue generated by the interactive multimedia. In addition, a user incentive, such as points or credit, can be calculated to provide to the user based on the revenue generated by the interactive multimedia. If the user donates part or all of the user incentive, the user can receive loyalty credit associated with a loyalty program that rewards the user for charitable actions, such as donating a portion of the user incentive to a charitable cause. If a user does not donate part or all of the user incentive, the user can use the points or credit to purchase goods or services.

Therefore, a customized advertisement is provided to the user. The corresponding advertiser knows that the user is registered to receive the interactive multimedia. Moreover, the advertiser can know that the user has been exposed to the interactive multimedia because the interactive multimedia has taken over a portion of the user's computing device, such as the background, screen saver, or the ringtone of the computing device. The user can benefit from receiving, registering for, or interacting with the interactive multimedia because the user can receive user credit for the interactive multimedia, thereby creating a benefit for the user to receive the customized interactive multimedia. A charitable cause can benefit from the user receiving, registering for, or interacting with the interactive multimedia because a portion of the revenue generated is donated to the charitable cause. The advertiser can additionally benefit from the advertisement by receiving a discount on the cost of providing the advertisement to the user if the advertiser provides a donation to a charitable cause. Additionally, in certain implementations advertisers can be provided with social tools to generate their own community of users that can follow their Corporate Social Responsibility (CSR) efforts. Moreover, a percentage of all advertising revenue generated in the future by that community can be donated directly towards that advertiser's CSR efforts. In addition, by generating a community of faithful users within the platform, advertisers can receive discounts on the advertising rate they will pay on the channel should for future advertising.

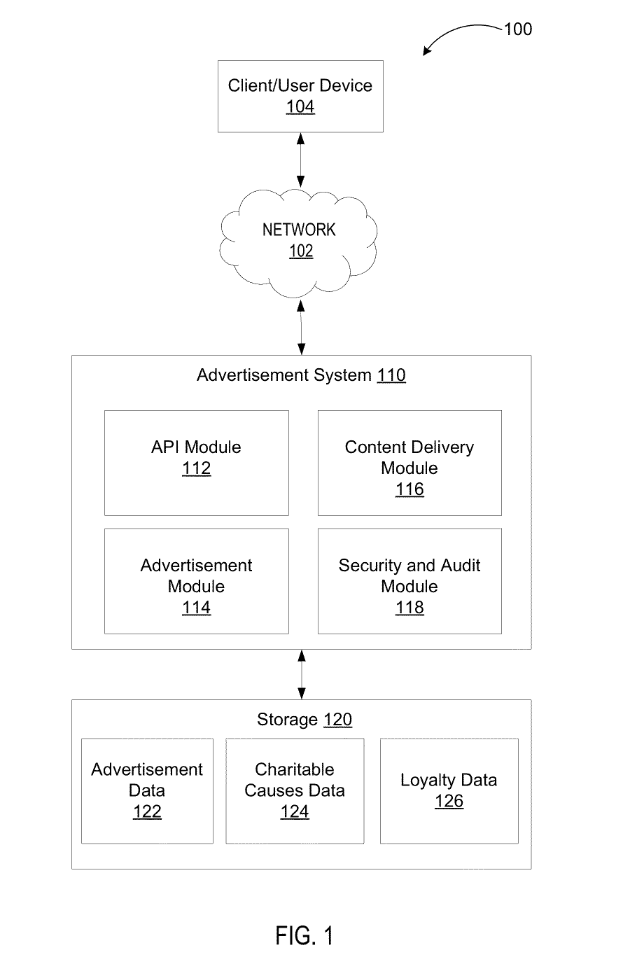

FIG. 1 illustrates an example system architecture 100, in accordance with one embodiment of the present disclosure. System 100 comprises a client/user device 104 in communication with (e.g., coupled to) an advertisement system 110 over a network 102, and a storage 120. The network 102 may be a private network (e.g., a local area network (LAN), a wide area network (WAN), intranet, etc.), a corporate network (e.g., a private network for an organization such as a corporation), a broadcast network, a public network (e.g., the Internet), a wired network (e.g., Ethernet network), a wireless network (e.g., an 802.11 network) and/or a cellular network (e.g., a Long Term Evolution (LTE) network).

The client/user device 104 may be any type of computing device, for example, a device including a processor, a computer-readable medium, and a memory. In some embodiments, the client/user device 104 may be executing a browser application, a mobile application, or other application adapted to communicate over Internet related protocols (e.g., TCP/IP and HTTP) and/or display a user interface. While only a single client/user device 104 is shown in FIG. 1, system 100 may support a large number of concurrent sessions with many client/user devices 104.

The advertisement system 110 may include computing devices that have a wide range of processing capabilities such a personal computer (PC), a server computer, a personal digital assistant (PDA), a smart phone, a laptop computer, a netbook computer, a tablet device, and/or any machine capable of executing a set of instructions (sequential or otherwise) that specify actions to be taken by that machine. Embodiments of the disclosure may operate within a single server device or on multiple server devices. Embodiments of the disclosure may operate as a standalone system.

Storage 120 can include one or more writable persistent storage devices, such as memories, tapes or disks. Although each of advertisement system 110 and storage 120 are depicted in FIG. 1 as single, disparate components, these components may be implemented together in a single device or networked in various combinations of multiple different devices that operate together. Examples of devices may include, but are not limited to, servers, mainframe computers, networked computers, process-based devices, and similar type of systems and devices.

Storage 120 may include advertisement data 122, charitable causes data 124, and loyalty data 126. Advertisement data 122 may include identification information for various interactive multimedia currently available, such as an identifier (e.g., name) of an advertiser associated with interactive multimedia, a description of the interactive multimedia, an audio file associated with the interactive multimedia (e.g., ringtone, audio description, etc.), a promotion associated with the interactive multimedia, a media item (e.g., video) associated with the interactive multimedia, etc. The interactive multimedia currently available in advertisement data 122 can be chosen based on a request by an advertiser to be included in the advertisement data 122. In The request by the advertiser can be based on a commitment by the advertiser to donate a portion of revenue earned by the advertiser to a charitable cause, a commitment by the advertiser to donate a portion of the revenue earned by the advertiser to the user, etc. Charitable causes data 124 may include identification information for various charitable causes, such as an identifier of the charitable cause (e.g., name, number, etc.), information associated with the charitable cause (e.g., causes supported by the charitable cause, etc.), etc. The charitable causes included in charitable causes data 124 can be selected by an administrator, by a computing device (not shown), etc. Loyalty data 126 may include identification information for users registered with the advertisement system 110, such as an identifier (e.g., name, identification number, etc.) of each user registered with the advertisement system 110 and a number of loyalty credits earned by each user. For example, identification information and loyalty credits for each user of the one or more client/user devices 104 can be included in loyalty data 126.

During operation of system 100, a user accesses system 100 via client/user device 104 over network 102. The advertisement system 110 receives communications from the client/user device 104, and processes and/or directs these communications accordingly.

As discussed above, conventionally, an advertiser has no knowledge of the user that is viewing the interactive multimedia, and therefore cannot customize the interactive multimedia to the specific user of the computing device. Moreover, the advertiser does not know if the user saw the interactive multimedia. This is so because, for example, browser-based cookies may not work on the mobile web or in mobile apps. Accordingly, when a user utilizes a mobile device, they may become ‘invisible’ to advertisers. In contrast, the technologies described herein can be tied to users profile, thereby providing detailed tracking info to advertisers that can be viewed from their own platform (accordingly, in certain implementations the technologies described herein can be thought of as serving as a “cookie”). In addition, neither the user nor a charitable cause can benefit from the interactive multimedia, other than the user or charitable cause possibly being exposed to the advertiser that sent the interactive multimedia (hearing of the company). The advertiser may benefit from the interactive multimedia if the user views or notices the interactive multimedia, but otherwise may not directly benefit from the interactive multimedia. A user of the client/user device 104 can register to receive interactive multimedia on the client/user device 104. An interactive multimedia is selected for the user based on preferences of the user, and the interactive multimedia is provided to the client/user device 104. The user and the advertiser associated with the interactive multimedia can benefit from the user receiving the interactive multimedia, and can further provide a benefit to a charitable cause.

In particular, in one embodiment, in response to a user registering to receive interactive multimedia on the client/user device 104, the advertisement system 110 provides the client/user device 104 with one or more interactive multimedia to present to the user and rewards (provides a benefit to) the user, a charitable cause, and the advertiser.

An embodiment of the advertisement system 110 may include an API module 112, an advertisement module 114, a content delivery module 116, and a security and audit module 118. The API module 112 can communicate with the client/user device 104 through the network 102. The API module 112 can receive a registration request from the client/user device 104 indicating that the user would like to receive interactive multimedia on the client/user device 104.

In response to the API module 112 receiving the registration request, the advertisement module 114 can determine interactive multimedia to provide to the user. The advertisement module 114 can select the interactive multimedia to provide to the user from advertisement data 122 based on one or more factors, such as user preferences provided by the user in the registration, a geographic location of the user, a time zone of the user, a country which the user is from or associated with, languages spoken by the user, etc.

Once one or more interactive multimedia have been selected by the advertisement module 114, the content delivery module 116 can provide the one or more interactive multimedia to the client/user device 104. In one embodiment, the content delivery module 116 formats the one or more interactive multimedia to be compatible with the client/user device 104, such as resizing the interactive multimedia, adjusting the interactive multimedia, etc. The content delivery module 116 can provide the one or more interactive multimedia as selected by the user as part of the user preferences. For example, the user preferences can indicate that the one or more interactive multimedia should be delivered as soon as the interactive multimedia have been selected, at a preselected time, at a preselected interval, etc. If more than one advertisement is selected, the content delivery module 116 can provide the interactive multimedia one at a time, in a group, etc., as requested by the user as part of the user preferences.

The advertisement module 114 can calculate a donation amount to be donated to a charitable cause in charitable causes data 126 based on revenue generated by the interactive multimedia. The revenue generated by the interactive multimedia may be based on the user's interaction with the interactive multimedia, such as by clicking on the interactive multimedia, listening to an audio file associated with the interactive multimedia, making a purchase based on the interactive multimedia, etc. The advertisement module 114 can calculate a user incentive, such as points or credit, to provide to the user based on the revenue generated by the interactive multimedia. The advertisement module 114 can further determine if the user donates part or all of the user incentive and can determine loyalty credit to provide to the user based on the user's donation. The advertisement module 114 can store information about the loyalty credit associated with the user in storage, such as in loyalty data 126. In one embodiment, the advertisement module 114 can further customize a website for an advertiser associated with interactive multimedia, and can calculate a discount for the cost of providing the interactive multimedia to a user if the advertiser is willing to donate a portion of the revenue generated from the interactive multimedia to a charitable cause, such as a charitable cause in charitable causes data 124. In an alternate embodiment, the advertisement module 114 can customize a website for an advertiser associated with interactive multimedia, and can cause a donation of a portion of the revenue generated from the interactive multimedia to a charitable cause, such as a charitable cause in charitable causes data 124.

The security and audit module 118 can provide security countermeasures to prevent identity forging, account harvesting, hacking, etc. The security and audit module 118 can further store and provide audit information for every request or transaction received by the advertisement system 110. The security and audit module 118 can detect unusual activity in the advertisement system 110.

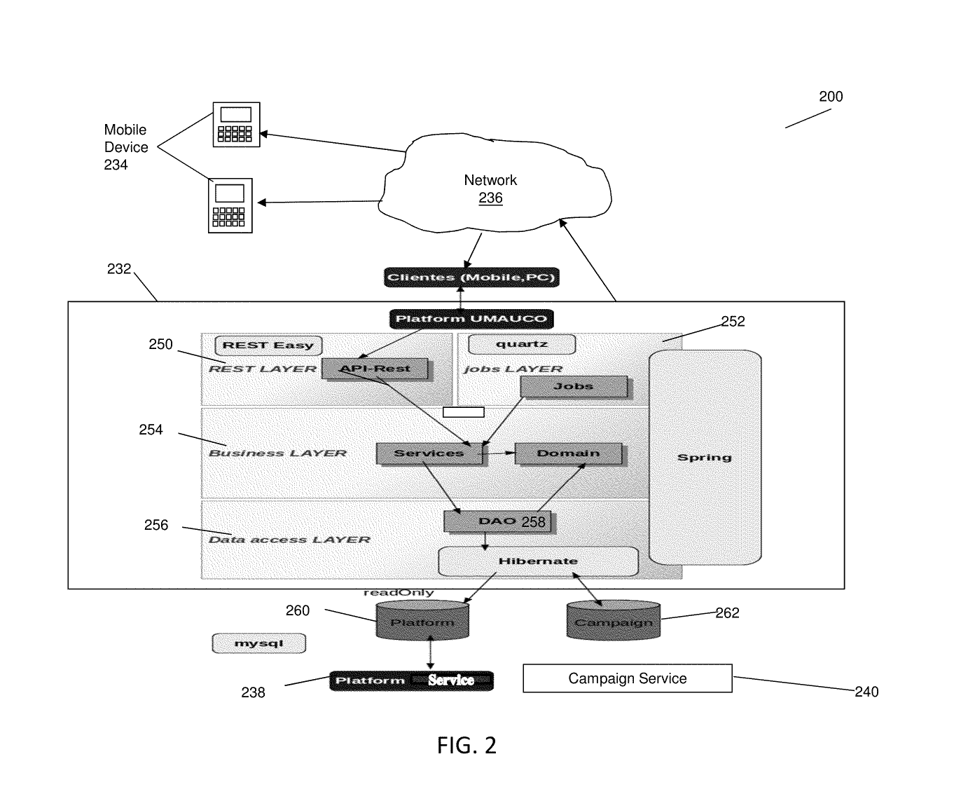

FIG. 2 illustrates an example system architecture 230, in accordance with one embodiment of the present disclosure. A customized advertising content management server computing device 232 communicates with a plurality of mobile devices 234 through a network 236. The network 236 may be a private network (e.g., a local area network (LAN), a wide area network (WAN), intranet, etc.), a corporate network (e.g., a private network for an organization such as a corporation), a broadcast network, a public network (e.g., the Internet), a wired network (e.g., Ethernet network), a wireless network (e.g., an 802.11 network) and/or a cellular network (e.g., a Long Term Evolution (LTE) network).

Mobile devices 234 may themselves be diverse in form and in function, and comprise by way of non-limiting example, smart phones, personal digital assistants (PDA's), tablet computers, laptop computers, desktop computers, computer servers, or other electronic communication devices capable of sending and receiving electronic messages, all as may be selected and particularly configured for use in the current system by those of ordinary skill in the art. The configuration of such mobile devices 234 are known to those of ordinary skill in the art, and thus are only generally described here by their key functional elements, which typically include a microprocessor for controlling overall operation of the device, a communications subsystem, and I/O subsystem, a serial port, a keyboard, a speaker, a microphone, memory (including RAM and flash memory for storing the devices operating system, programs, and data), BLUETOOTH and/or WI-FI communications modules, a touch screen, and a SIM card or other removable user identity module (RUIM).

The mobile devices 234 communicate with customized advertising content management server computing device 232 through a wireless connector system, such as a wireless network operated by a mobile network provider, an organization or enterprise specific wireless network, or the like. Mobile devices 234 connect through such wireless network to resources and services offered by customized advertising content management server computing device 232, including messaging, content (e.g., Internet content), applications, and the like. Such wireless network may provide for secure and/or encrypted communications to and among mobile devices 234, and may provide at least a portion of the network 236 that allows customized advertising content management server computing device 232 to communicate with mobile devices 234 to place interactive multimedia on one or more of mobile devices 234.

Customized advertising content management server computing device 232 provides applications intended to receive and send interactive multimedia campaigns, including wallpapers, ringtones, and rich content from and to a variety platforms executing on mobile devices 234. Overall, such applications execute a campaign, which is a synchronization and push/pull service to provide interactive multimedia to the mobile devices 234. The campaign focuses on scalability, performance and a distributed approach.

A platform service 238 and a campaign service 240 are in communication with customized advertising content management server computing device 232. The campaign service 240 exposes a REST Application Programming Interface (API) to allow the platform service 238 to interact with the customized advertising content management server computing device 232.

The campaign service 240 can manage the executions of campaigns once the campaigns have been approved by an administrator (e.g., program administrator, system administrator, etc.). The campaign service 240 can create new executions on an ongoing basis. For example, the campaign service 240 can create a new every day, until a given objective (e.g., a number of devices that received the campaign) is reached, etc. The given objective may include delivery of the campaign to a particular number of mobile devices 234. The campaign service 240 can communicate with mobile devices 234 to notify a user associated with each mobile device 234 of a new campaign. The campaign service 240 can receive the results of the execution of a campaign from the mobile devices 234 that receive the campaign. The results may then be used to calculate an incentive amount for the user that may be used by the platform service 238 to assign a user credit or points to the user.

The campaign service 240 can provide an API for activating a campaign to start executing the campaign, an API to synchronize with a mobile device 234 (e.g., receive and process results from a previous campaign, return new campaigns to the mobile device 234, etc., an API to retrieve and return campaign status and results, an API to retrieve and return users' scores regarding the campaigns, etc. Campaign service 240 can automatically create executions for active campaigns, match devices (and users) to campaigns, and change successful campaign status to indicate that the campaign has completed or finished.

Customized advertising content management server computing device 232 can includes multiple logical layers that have specific functions, such as rest layer 250, a jobs layer 252, a business layer 254, and a data access layer 256. The rest layer 250 can expose an API for external systems to interact with an application. Therefore, the rest layer 250 can be the entry point to the application. The rest layer 250 can expose different resources to allow platform service 238 and the mobile devices 234 to retrieve and modify data. The rest layer 250 can perform data transformation and Multipurpose Internet Mail Extensions (MIME) type handling.

Jobs layer 252 causes customized advertising content management server computing device 232 to execute logic at certain occurrences other than when requested via the rest layer 250, in order to match users to campaigns before the campaign execution starts. Jobs layer 252 triggers the logic by calling the business layer 254, discussed below, when configured.

Business layer 254 can contain services and domain entities. The services can expose functionality to the rest layer 250 and implement the functionality by coordinating the work, such as by collaborating with other services, the domain entities, etc. The services in the business layer 254 can interact with the data access layer 256 (discussed below) to persist the domain entities. Some technical features can be implemented in this layer, such as transaction management. Domain entities can be responsible for representing concepts of the business, information about the business situation, and business rules, such as by interacting with each other. The state that reflects the business situation can be controlled and used by the business layer 254, even though the technical details of storing the state that reflects the business situation can be performed by data access layer 256. Each domain entity encapsulates the structure and behavior of a business entity.

Data access layer 256 can provide persistence of domain entities and other information in a database (not shown). Data access layer 256 can isolate the rest of the application from technical details and issues related to persistence. In one embodiment, data access layer 256 includes Data Access Objects (DAO) 258 and Object Relational Mapping (ORM) (not shown). A persistence strategy can be decoupled from the rest of the application by implementing a DAO design pattern. The DAO 258 can access the persistence framework and the complex database queries. Likewise, the ORM can be the framework responsible for interacting with a database server and mapping objects to a relational model.

The system 200 can include a platform database 260 and a campaign database 262. The platform database 260 can include information used by platform service 238 to manage a portal. The platform service 238 can further perform the creation, reading, updating, and deleting (CRUD) of campaigns, users, devices, countries, cities, interests, etc. in the platform database 260. The campaign service 240 can access the platform database 260. In one embodiment, the campaign service 240 accesses the platform database 260 in read-only mode. In an alternate embodiment, the campaign service 240 accesses the platform database 260 in a read-write mode. The campaign database 262 can include information used by campaign service 240, including information about campaign executions, matches, and results.

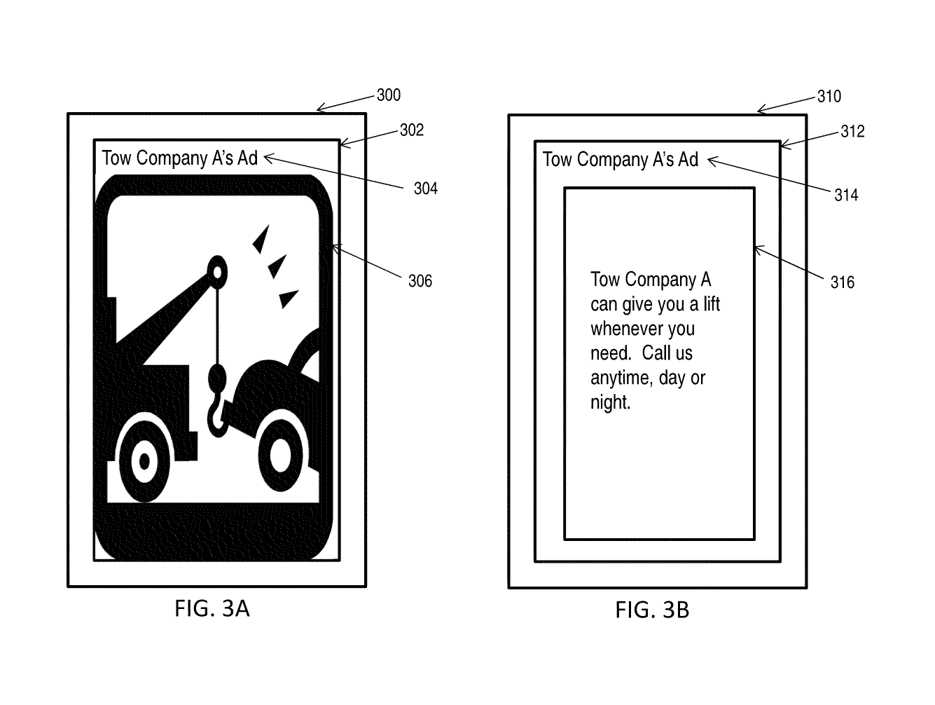

FIG. 3A illustrates an example user interface 300 for providing interactive multimedia as a visual wallpaper according to various implementations. The user interface 300 can be created in response to the user requesting to receive interactive multimedia, on a periodic basis (e.g., every hour), etc. The user interface 300 can include an advertisement 302. The advertisement 302 can be visually presented as the wallpaper of a computing device of a user (e.g., as the background to the user interface of the device and/or the lock screen of the device). The advertisement 302 can include an advertisement identifier 304 and visual content 306. The advertiser identifier 304 can include an identifier for an advertiser associated with the interactive multimedia, an identifier for a campaign associated with the identifier, promotion information for the interactive multimedia, etc. For example, the advertiser identifier 304 identifies the advertisement 302 as “Tow Company A's Ad.” The visual content 306 can be a picture, a graphic, a video, or any other visual representation associated with the interactive multimedia. For example, the visual content 306 is a graphic of a tow truck towing a car, which represents the type of service that the advertiser identified by advertiser identifier 304 can provide to a user.

FIG. 3B illustrates an example user interface 310 for providing interactive multimedia as a textual description according to various implementations. The user interface 310 can be created in response to the user requesting to receive interactive multimedia, on a periodic basis (e.g., every hour), etc. The user interface 310 can include an advertisement 312. The advertisement 312 can be visually presented as the wallpaper of a computing device of a user. The advertisement 312 can include an advertisement identifier 314 and textual content 316. The advertiser identifier 314 can include an identifier for an advertiser associated with the interactive multimedia, an identifier for a campaign associated with the identifier, promotion information for the interactive multimedia, etc. For example, the advertiser identifier 314 identifies the advertisement 312 as “Tow Company A's Ad.” The textual content 316 can be a textual description or representation associated with the interactive multimedia. For example, the textual content 316 represents that “Tow Company A can give you a lift whenever you need. Call us anytime, day or night,” which represents the type of service that the advertiser identified by advertiser identifier 314 can provide to a user.

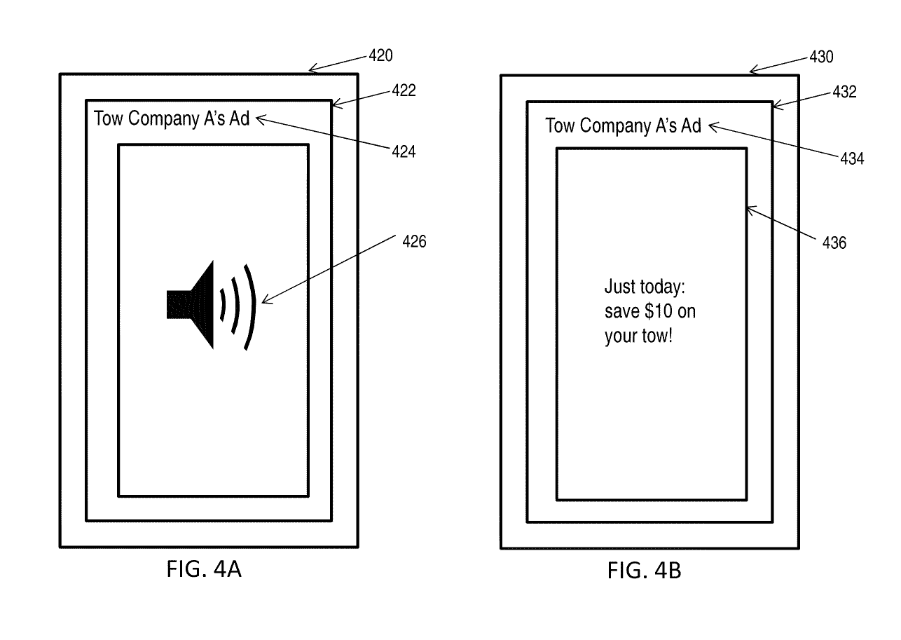

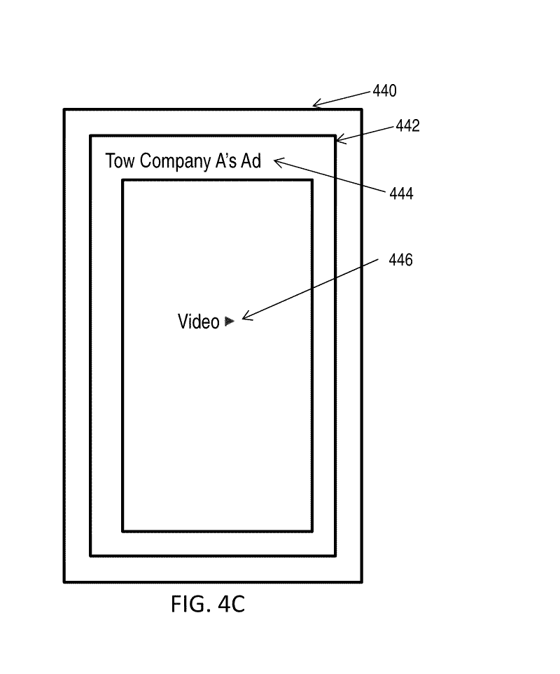

FIG. 4A illustrates an example user interface 420 for providing interactive multimedia as a ringtone according to various implementations. The user interface 420 can be created in response to the user requesting to receive interactive multimedia, on a periodic basis (e.g., every hour), etc. In one embodiment, the user interface 410 can include an advertisement 422. In this embodiment, the advertisement 422 can be visually presented as the wallpaper of a computing device of a user and can include an advertisement identifier 424. The advertiser identifier 424 can include an identifier for an advertiser associated with the interactive multimedia, an identifier for a campaign associated with the identifier, promotion information for the interactive multimedia, etc. For example, the advertiser identifier 424 identifies the advertisement 422 as “Tow Company A's Ad.” In an alternate embodiment, the user interface 420 does not include any visual elements. The user interface 420 can include an audio file 426 that is played by the computing device displaying the user interface 420. The audio file 426 can be a ringtone or other audible information associated with the interactive multimedia. For example, the user interface 420 or the computing device displaying the user interface 420 can audibly play the audio file 426 as a ringtone that says “Tow Company A can give you a lift whenever you need. Call us anytime, day or night” whenever the computing device to which the audio file is provided receives a phone call (e.g., the ringtone of the device can be changed automatically in this manner, and once a phone call has ended the user can be prompted to go to an interactive ad corresponding to the particular ringtone). In another example, the user interface 420 or the computing device displaying the user interface 420 can audibly play the audio file 426 that says “Tow Company A can give you a lift whenever you need. Call us anytime, day or night” whenever the audio file 426 is selected (e.g., by a user). In an additional example, the user interface 420 or the computing device displaying the user interface 420 can audibly play the audio file 426 that says “Tow Company A can give you a lift whenever you need. Call us anytime, day or night” when the advertisement 422 is delivered to the computing device displaying the user interface 420.

FIG. 4B illustrates an example user interface 430 for providing interactive multimedia as a visual promotion according to various implementations. The user interface 430 can be created in response to the user requesting to receive interactive multimedia, on a periodic basis (e.g., every hour), etc. The user interface 430 can include an advertisement 432. In one embodiment, the advertisement 432 is visually presented as the wallpaper of a computing device of a user. In an alternate embodiment, the advertisement 432 is visually presented as a message (e.g., SMS, file, email, etc.) on the computing device of a user. The advertisement 432 can include an advertisement identifier 434 and promotional content 436. The advertiser identifier 434 can include an identifier for an advertiser associated with the interactive multimedia, an identifier for a campaign associated with the identifier, promotion information for the interactive multimedia, etc. For example, the advertiser identifier 434 identifies the advertisement 432 as “Tow Company A's Ad.” The promotional content 436 can be a description or representation associated with a promotion being offered by the interactive multimedia. For example, the promotional content 436 represents that “Just today: save $10 on your tow,” which represents a promotion associated with the type of service that the advertiser identified by advertiser identifier 434 is providing to the user of the computing device.

FIG. 4C illustrates an example user interface 440 for providing interactive multimedia as a video according to various implementations. The user interface 440 can be created in response to the user requesting to receive interactive multimedia, on a periodic basis (e.g., every hour), etc. The user interface 440 can include an advertisement 442. In one embodiment, the advertisement 442 is visually presented as part of the wallpaper of a computing device of a user. In an alternate embodiment, the advertisement 442 is presented as a message (e.g., SMS, file, email, etc.) to the user. The advertisement 442 can include an advertisement identifier 444 and video content 446. The advertiser identifier 444 can include an identifier for an advertiser associated with the interactive multimedia, an identifier for a campaign associated with the identifier, promotion information for the interactive multimedia, etc. For example, the advertiser identifier 444 identifies the advertisement 442 as “Tow Company A's Ad.” The video content 446 can be a description or representation of a video associated with the interactive multimedia. The video content 446 can provide a user interface element for a user to select in order to play the video. For example, the video content 446 includes the name of the video “Video” and a small triangle next to the name of the video which the user can press in order to play the video. Upon playing the video, the user can know the type of service that the advertiser identified by advertiser identifier 444 can provide to a user.

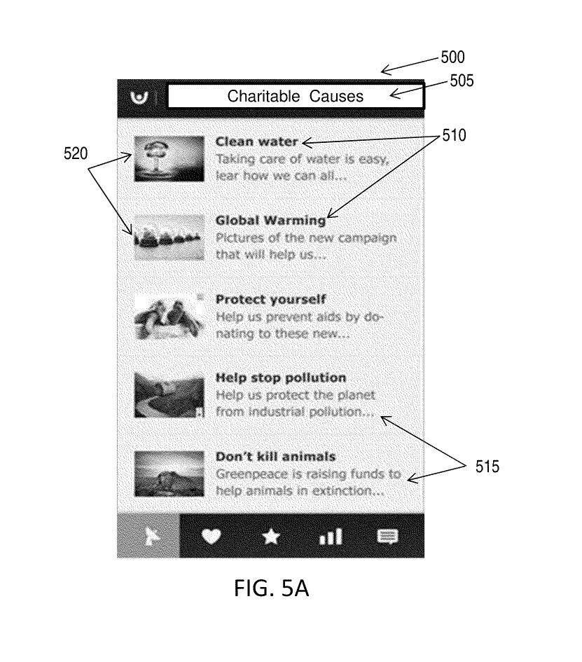

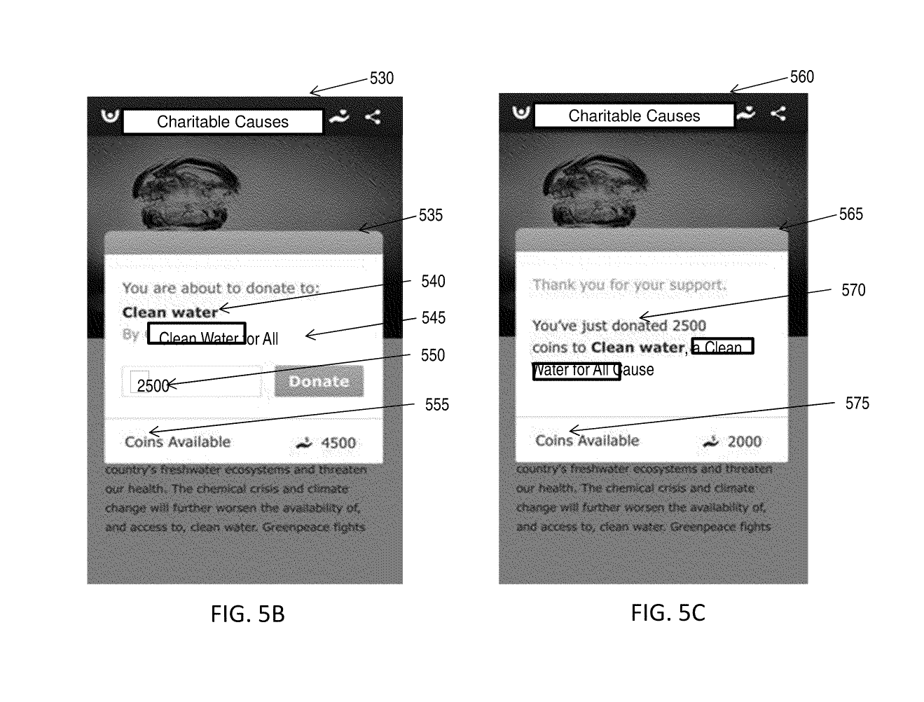

FIG. 5A illustrates an example user interface 500 for providing a list of charitable causes according to various implementations. The user interface 500 can be displayed in response to the user requesting the list of charitable causes. For example, the user interface 500 can be displayed in response to the user requesting to donate to a charitable cause. The user interface 500 can include a list of one or more charitable causes 505. The list of charitable causes 505 can include an identifier 510 for one or more of the charitable causes in the list of charitable causes 505. In one embodiment, the list of charitable cause 505 can further include a description for each of the charitable causes in the list of charitable causes 505. In one embodiment, the list of charitable cause 505 can further include a graphic representation 520 of the charitable cause. For example, the list of charitable causes 505 includes a charitable cause for clean water, which is described to be a charitable cause taking care of water, and has a graphic representation 520 of a geyser.

FIG. 5B illustrates an example user interface 530 to allow a user to donate to a charitable cause according to various implementations. The user interface 530 can be displayed in response to the user providing an indication that the user would like to donate to a charitable cause. For example, the user interface 530 can be displayed in response to the user requesting to donate to a specific charitable cause. The user interface 530 can include a window 535. The window 535 can include the charitable cause 540 that has been indicated by the user as the charitable cause the user would like to donate to. The window 535 can also include an identifier of a charitable organization 545 that is associated with the charitable cause and to which the donation will go to. The window 535 can further include a donation amount 550 to the charitable cause 540. The window 535 can further include a user incentive amount 555 that is available to the user to donate. The user incentive amount 555 can be a number of points or coins that the user has earned in return for allowing interactive multimedia to be provided to a computing device of the user. For example, the window 535 includes an identifier of the charitable cause 535 for clean water by a charitable organization 545 called “Clean Water for All.” In this example, the window 535 includes a donation amount 550 of 2500 coins and a user incentive 555 of 4500 coins available to the user.

FIG. 5C illustrates an example user interface 530 to provide confirmation to a user of a donation made to a charitable cause according to various implementations. The user interface 560 can be displayed in response to the user submitting a donation to a charitable cause. The user interface 560 can include a window 565. The window 565 can include a message 570 that the user has successfully donated to the charitable cause. The message 570 can include an identifier of the charitable cause, a donation amount made to the charitable cause, the name of a charitable organization associated with the charitable cause, etc. For example, the message 570 states to a user that “You've just donated 2500 coins to Clean water, a Clean Water for All cause.” The window 535 can include a user incentive amount 575 associated with the user making the donation. The user incentive amount 575 can be the remaining amount available to the user to spend or make additional donations with upon making the current donation. For example, the user incentive amount 575 is 2000 coins, which is the amount of coins that the user has remaining after donating 2500 coins to the charitable cause. The user incentive amount 575 can be a number of points or coins that the user has earned in return for allowing interactive multimedia to be provided to a computing device of the user.

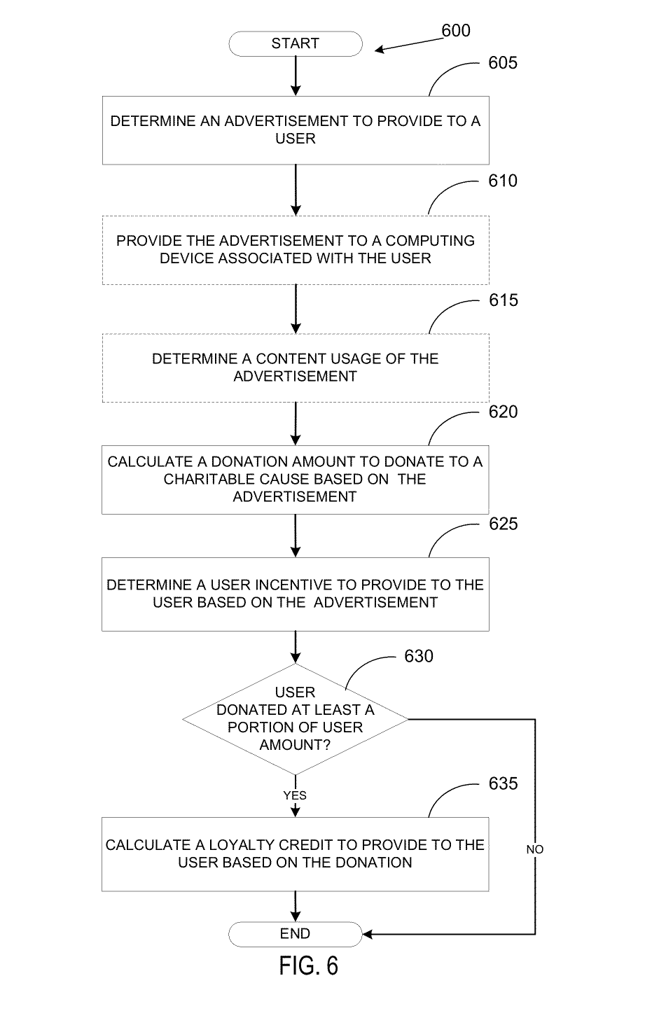

FIG. 6 is a flow diagram illustrating an embodiment for a method 600 of directing interactive multimedia to computing devices. The method 600 may be performed by processing logic that may include hardware (e.g., circuitry, dedicated logic, programmable logic, microcode, etc.), software (e.g., instructions run on a processing device to perform hardware simulation), or a combination thereof. In one embodiment, the method 600 is performed by a server (e.g., the advertisement system 110 of FIG. 1).

At block 605, processing logic determines interactive multimedia to provide to a user. In one embodiment, processing logic determines the interactive multimedia in response to a user request for the interactive multimedia. In this embodiment, the user can request the interactive multimedia using a computing device associated with the user, such as a mobile device associated with the user, a computer associated with the user, etc. For example, the user requests interactive multimedia from his mobile phone when going to lunch in order to receive interactive multimedia for a nearby restaurant.

In an alternate embodiment, processing logic determines the interactive multimedia to provide to a user on a periodic basis, such as hourly, weekly, etc. The periodic basis can be defined by an advertising system, by the user, etc. For example, the user indicates in a user profile or user preferences that the user would like to receive interactive multimedia on a daily basis.

In another alternate embodiment, processing logic determines the interactive multimedia to provide to a user in response to the registration of the user to receive interactive multimedia. In one such embodiment, the user registers to receive interactive multimedia by installing an application on a computing device and registering with the application. In one embodiment, the user registers directly with the application by providing an identification of the user (e.g., full name, user name, etc.), an email address, and a password. In response, the application can send an email to the email address provided by the user and the user can verify that the user received the email. In an alternate embodiment, the user registers indirectly with the application using a third party account, such as a social media account (e.g., Google®, Facebook®, Twitter®, etc.). In this embodiment, the user registers indirectly by providing the user's login information for the third party account. As part of the registration process, the user can create a user profile. The user profile can include information about the user, such as a geographic location for the user (e.g., country, city, address, etc.), important dates for the user (e.g., the user's birthday, the user's anniversary, the user's spouse's birthday, religious holidays, non-religious holidays, etc.), brands that the user likes and/or dislikes, interests of the user, hobbies of the user, food/cuisines enjoyed by the user, property owned or used by the user (e.g., the make, model, and year of the car driven by the user, that the user owns a home, etc.), and other personal information about the user that can be used by processing logic to determine interactive multimedia to provide to the user. The user profile can further include preferences of the user, such as an amount of time that the user is willing to be exposed to interactive multimedia (e.g., 2 hours, 1 week, etc.), a period of time that the user is willing to be exposed to interactive multimedia (e.g., day, night, etc.), etc.

Interactive multimedia can be created by an advertiser. In one embodiment, the interactive multimedia to provide to the user includes advertisement content, a display time range for the interactive multimedia, and a value for each display time range that can be provided to the user in exchange for the user's agreement to have the interactive multimedia display on a computing device of the user. The interactive multimedia can further include a specific hour span or date for display of the interactive multimedia selected by the user, such as only at particular times of the day or night, on dates of particular relevance, at particular dates of significant interest (e.g., Christmas), etc.

In an alternate embodiment, the interactive multimedia to provide to the user is one or more campaigns to provide to the user. Each campaign can include a start date and time, an end date and time, and campaign information. The campaign information can include information specific to the campaign, such as an identifier (e.g., name) of the campaign, a description of the campaign, a type of the campaign associated with an objective (e.g., wallpaper, wallpaper and ringtone, ringtone, last minute, birthdate, default, etc.), and data associated with the type of the campaign. For example, a wallpaper campaign for “Tow Truck Company A” can start today and end a week from today. In this example, the data associated with the campaign includes the wallpaper associated with Tow Truck Company A to be provided to computing devices and displayed as the wallpaper on the computing devices of users receiving the campaign. In another example, if the type of the campaign is a wallpaper and ringtone campaign, the data associated with the campaign will include the wallpaper and ringtone to be provided to the computing devices of users receiving the campaign.

In some embodiments, processing logic can determine interactive multimedia to provide to a user based on an auction. In these embodiments, the interactive multimedia can be offered on an auction basis, allowing advertisers to bid to be able to provide the interactive multimedia to the user. For example, interactive multimedia that is date specific, such as interactive multimedia directed to a user on the user's birthday or on particular holiday, may be offered to multiple advertisers to bid on, with the winning bidder being offered the opportunity to provide interactive multimedia to the user for an exclusive, limited period of time.

In some embodiments, multiple advertisers may wish to provide the same advertising impressions (e.g., offers that are provided to a specific user on a date of interest to that user, whether a specific holiday, a birthday, an anniversary, or the like). However, in order not to overload the user with a large number of interactive multimedia sharing such impression, processing logic can limit the number of advertisers that may use such an impression in a single instance. If more than one advertiser has opportunity to provide interactive multimedia to a user that makes up such an impression (such as by multiple advertisers having purchased such particular advertising impression that meets certain demographic and behavioral fields), and such impression is not available (e.g., one advertiser has already used such impression for a specific instance, such as the user's birthday), processing logic can determine to wait until the next available slot that meets those demographic and/or behavioral fields becomes available, and provide that instance to the next advertiser that has purchased the same impression to provide interactive multimedia to the user, and the interactive multimedia may then be provided to the user.

In one embodiment, processing logic determines interactive multimedia to provide to the user that is customized to the user by selecting an active advertisement to provide to the user based on the user profile associated with the user. Processing logic can determine the active advertisement that is customized to the user based on the user profile by selecting an active advertisement that best matches the information in the user profile. Interactive multimedia is active if an account balance associated with the interactive multimedia has one or more credits. The advertiser that created the account can purchase credits for the advertiser or for the interactive multimedia. When interactive multimedia associated with the advertiser or the interactive multimedia is provided to a user, the number of credits in the account balance associated with the interactive multimedia is decremented. For example, if the account balance associated with interactive multimedia is 10 and the interactive multimedia is provided to 2 users, the account balance associated with the interactive multimedia will be decremented by 2, leaving an account balance of 8. Processing logic can compare the active interactive multimedia to the information in the user profile and select the active advertisement that most closely meets the information in the user profile. For example, a user profile includes information that the user lives in France and enjoys German cuisine, and there are two interactive multimedia available, the first advertisement for an Italian restaurant in France and the second advertisement for a German restaurant in England. In this example, processing logic selects the interactive multimedia for the Italian restaurant in France, as it is unlikely that the user will want to travel to England to eat at the German restaurant.

In one embodiment, processing logic determine the interactive multimedia to provide to the user that is customized to the user based on the user profile associated with the user and other external information, such as a current geographic location of the user (e.g., obtained using a Global Positioning System, etc.), the current date (e.g., obtained from a system clock of the computing device, from an external system, etc.). For example, a user profile includes information that the user lives in France and enjoys German cuisine, has a current geographic location in England, and there are two interactive multimedia available, the first advertisement for an Italian restaurant in France and the second advertisement for a German restaurant in England. In this example, using the current geographic location of England for the user as well as the user preference for German food, processing logic determines the interactive multimedia that is customized to the user as the second advertisement (German restaurant in England). In another example, processing logic determine from the user profile that the user's anniversary is in 2 days and selects interactive multimedia for a local jewelry store to provide to the user. In another example, external information indicates that the current date is Valentine's Day, the user profile includes information that the user is married, and the user's current geographic location is near a florist and a drugstore. In this example, there are two interactive multimedia: interactive multimedia for Valentine's Day flowers from the florist and interactive multimedia for over-the-counter medication from the drugstore. In this example, processing logic processes the information that the user is married and it is Valentine's Day, and determines the interactive multimedia for Valentine's Day flowers from the florist as the interactive multimedia to provide to the user. However, in this example, if the user profile further indicates that the user is boycotting the florist because of bad business practices, processing logic will determine the interactive multimedia for the drugstore as the interactive multimedia to provide to the user.

In one embodiment, processing logic customizes the interactive multimedia determined to provide to the user. Processing logic can customize the interactive multimedia by including a personalized message specifically directed to the user of the computing device. The personalized message can be a pop-up message, desktop background, a wallpaper, a customized audio file, etc., that the user can consume (view, hear, etc.) when interacting with the computing device associated with the user. The personalized message can be interactive to allow the user to interact with the personalized message, with the interactive multimedia, or with a website associated with the interactive multimedia. For example, the user profile of user John Smith indicates that it is John's twenty-fifth birthday and processing logic determines to provide the user with interactive multimedia for a beverage. In this example, processing logic customizes the interactive multimedia by including a personalized message stating “Hello John Smith. The XYZ Cola Company wishes you a very happy 25^{th} birthday! Please go to our website and find your special birthday gift waiting for you!” In this example, the interactive multimedia is specifically formatted for the intended user (delivered on the user's actual 25^{th} birthday), and is interactive, allowing the user to engage a link (“website” in the above message) which may navigate the user to the related product or advertiser's website. The product or advertiser's website may, in turn, provide a coupon for use by the user either on an online purchase or alternatively for offline use, such as by simply displaying the coupon on the computing device to a retailer that accepts such coupons.

In one embodiment, processing logic further customizes the interactive multimedia determined to provide to the use based on interactive multimedia that were previously successful for the user. Processing logic can use a record of the user's interactions with previous interactive multimedia to determine the interactive multimedia that were previously successful.

In one embodiment, processing logic customizes the interactive multimedia determined to provide to the use based on a user incentive amount associated with the user. For example, a user that has a large user incentive amount can receive a better or higher value offer, a larger discount, etc. than a user who has a smaller user incentive amount. Likewise, the campaign may be customized so that very high value offers may be reserved for and presented only to users whose profile maintains a certain minimum number of points that may be designated by the advertising content provider. Still further, the campaign may be customized to provide a campaign in which the value of a specific offer is determined by each user's level of donations, such as the total dollar value of cash donations made by each user, to certain charitable causes. In this case, the causes may optionally be causes that are voted on by a number of users of the system as socially important, and the offer value may be further dependent upon the votes that have been cast for the cause to which the user has made a donation. Further, the offer value may be further customized to depend upon the total level or economic value of the user's donation.

At optional block 610, processing logic provides the interactive multimedia to a computing device associated with the user. In this embodiment, processing logic can configure the interactive multimedia to a computing device associated with the user, such that the interactive multimedia can be properly displayed on a user interface of the device. Processing logic can provide the interactive multimedia to the user by transmitting information to the computing device associated with the user. For example, processing logic can transmit the information as a data packet in the form of a message, notification, or the like particularly configured for the platform on which the computing device associated with the user is operating. The information can include the interactive multimedia (e.g., new wallpaper, ringtone, etc.), and an executable instruction that causes the computing device to update the user interface on the computing device to ensure that the interactive multimedia is presented to the user as intended. The information can include an instruction causing the computing device to change a portion (e.g., wallpaper, ringtone, etc.) of the computing device to include the interactive multimedia. For example, if the interactive multimedia is to be displayed on the wallpaper of the computing device as an ad for Tow Truck Company A, processing logic transmits the interactive multimedia for Tow Truck Company A and an instruction to change the wallpaper of the computing device. In this example, upon receiving the instruction and the interactive multimedia, the computing device of the user will execute the instruction and change the wallpaper of the computing device to include the interactive multimedia for Tow Truck Company A. In one embodiment, the computing device of the user will execute the instruction and change the wallpaper of the computing device only when the user is logged in or has otherwise provided information indicating that the user would like to have the wallpaper of the computing device changed.

Upon receiving the instruction and the interactive multimedia, the computing device associated with the user can lock the portion of the computing device that includes the interactive multimedia for a predefined amount of time. The predefined amount of time can be defined by the user preferences associated with the user, by the advertiser associated with the interactive multimedia, by an advertisement system, etc.

When interacting with interactive multimedia that has been delivered to the user's computing device, the computing device can present the user with interactive options, such as saving the interactive multimedia to a list of “favorites” for future use; resending interactive multimedia or discount offer to friends or contacts, such as friends or contacts within the user's online social network community; electronically navigating to the advertiser's website; viewing a video advertisement provided by the advertiser; engage the advertiser's electronic, online ordering system to make a purchase; etc. Processing logic can maintains a record of the user's interaction with each advertisement that is sent to a computing device associated with the user. For example, processing logic can record when the user viewed interactive multimedia, when the user engaged links in interactive multimedia, when the user made a purchase after receiving interactive multimedia, when the user declined a purchase after receiving interactive multimedia, etc. Based upon the record of the user's interaction with the interactive multimedia, processing logic can customize future interactive multimedia to take advantage of interactive multimedia that are most successful (based on the particular interactions the user had with a given advertisement).

At optional block 615, processing logic determines a content usage of the interactive multimedia. Processing logic can determine the content usage of the interactive multimedia by periodically determining whether an objective associated with the interactive multimedia is met and calculating the content usage based on whether the objective is met over a period of time associated with the interactive multimedia.

Processing logic can determine whether an objective associated with the interactive multimedia is met by comparing the interactive multimedia on the computing device with the interactive multimedia that should be displayed on the computing device for a series of time intervals. The time interval can be a predefined period, such as 5 minutes. For a wallpaper advertisement, if the wallpaper currently on the computing device matches the wallpaper for the current advertisement, the objective of the interactive multimedia is met. For example, a wallpaper advertisement is scheduled and the time interval is 5 minutes. In this example, processing logic will check every 5 minutes to determine if the wallpaper on the computing device matches the wallpaper for the current advertisement.

Processing logic can calculate the content usage based on whether the objective is met over a period of time associated with the interactive multimedia. The period of time associated with the interactive multimedia can be a length of time that the interactive multimedia is supposed to be displayed on a computing device of a user. For example, if interactive multimedia is scheduled to run for an hour, the period of time is an hour, or 60 minutes. Processing logic can calculate the content usage based on the time the interactive multimedia has been active and the successful checks of the objective. In one embodiment, processing logic calculates the content usage as a ratio of the number of time intervals that the objective is met and the total number of time intervals. For example, interactive multimedia is scheduled to run for an hour and the time interval is 5 minutes. In this example, there are 12 time intervals. However, the last time interval can be ignored or discarded because it may collide with the first time interval of the next advertisement, such that there are 11 time intervals. At every time interval (every 5 minutes), processing logic determines if the objective is true or false (e.g., correct wallpaper is displayed on the computing device). Processing logic calculates the content usage as a ratio of the number of time intervals that the objective was true and the number of total time intervals. Therefore, if all 11 time intervals had an objective that was true, the content usage is 11/11=100%. If 6 of the time intervals had an objective that was true, the content usage is 6/11=55%.

At block 620, processing logic calculates a donation amount to donate to a charitable cause based on the interactive multimedia. In one embodiment, the donation amount to donate to the charitable cause is a predefined percentage of the revenue generated by the interactive multimedia, such as 20%, 40%, etc. For example, if the revenue generated by the interactive multimedia is $10, the donation amount is 40% of $10, or $4. In an alternate embodiment, the donation amount to donate to the charitable cause is a predefined percentage of the earnings generated by the interactive multimedia, such as 20%, 40%, etc. In another alternate embodiment, the donation amount to donate to the charitable cause is a predefined percentage of the profit generated by the interactive multimedia, such as 20%, 40%, etc.

At block 625, processing logic calculates a user incentive to provide to the user based on the interactive multimedia. In some embodiments, the user's circle of influence, such as their linked online community of “friends” or the like in online social network platforms, may be compensated for allowance placement of interactive multimedia. The user incentive can be any type of compensation, including points, cash, prizes, discounts, a percentage of all revenue generated, free communication time, etc. In one embodiment, the user incentive to provide to the user is a predefined percentage of the revenue or earnings generated by the interactive multimedia, such as 20%, 40%, etc. For example, if the revenue generated by the interactive multimedia is $10, the user incentive is 40% of $10, or $4. In one embodiment, the predefined percentage of the revenue used to calculate the user incentive is the same as the predefined percentage of the revenue used to calculate the donation amount. For example, if the predefined percentage of the revenue to calculate the donation amount is 40%, then the predefined percentage of the revenue to calculate the user incentive is also 40%.

In some embodiments, processing logic updates the amount of the user incentive if the user interacted with the interactive multimedia. Processing logic can determine whether the user interacted with the interactive multimedia based on a record of the user's interaction with each advertisement sent to a computing device associated with the user. Processing logic can increase the user incentive by a predefined amount for each interaction. Different interactions can increase the user incentive by different amounts. For example, saving the interactive multimedia to a list of “favorites” for future use can increase the user incentive by 5 points, resending interactive multimedia or discount offer to friends or contacts can increase the user incentive by 10 points; electronically navigating to the advertiser's website can increase the user incentive by 15 points; viewing a video advertisement provided by the advertiser can increase the user incentive by 3 points, engaging the advertiser's online ordering system to make a purchase can increase the user incentive by 20 points, and purchasing a product associated with the interactive multimedia can increase the user incentive by 30 points.

In some embodiments, processing logic updates the amount of the user incentive if the user shared the interactive multimedia with others. The user's profile may include a listing of contacts with whom the user would like to share interactive multimedia. The system may prompt a user to send their contacts a special greeting (including interactive multimedia incorporated in wallpaper, a ringtone, or the like as described above) for such contact's birthday, special date, or other occasion. Optionally, “friends” within a social network may bid to send another, specifically identified friend in such network such a special greeting, similar to the manner described above in which advertising content providers may bid for a given advertising impression. Processing logic can increase the user incentive by a predefined amount for each time the user shared the interactive multimedia.

In some embodiments, processing logic updates the amount of the user incentive if the user has purchased a product associated with a socially responsible company. For example, if the user purchases a product from company A, which has been categorized as a socially responsible company (e.g., given a seal of approval), the user can be rewarded with an additional user incentive. For example, the user can be rewarded 10 points.

At block 630, processing logic determines whether the user donated at least a portion of the user incentive. Processing logic can determine whether the user donated at least a portion of the user incentive to a charitable cause. Processing logic can determine whether the user donated at least a portion of the user incentive based on transactions performed by the user. The transactions performed by the user track what the user is using the user incentive for. The user incentive can be cumulative and can include user incentives received from other interactive multimedia. If processing logic determines that the user did not donate at least a portion of the user incentive, the user can retain the credit and method 600 ends. If processing logic determines that the user donated at least a portion of the user incentive, the method 600 proceeds to block 635.

At block 635, processing logic calculates a loyalty credit to provide to the user based on the donation. The loyalty credit can be used for a loyalty program that rewards the user for charitable actions taken by the user, such as by donating the user incentive to a charitable cause. The loyalty program can recognize one or more of the users who share or donate the most to charitable organizations on a periodic basis, such as monthly, yearly, etc. For example, the single user in the world that donated the most can be recognized in a yearly competition. The loyalty credit can be a portion of the revenue or earnings set aside to reward users that are charitable. For example, 1 percent of revenue or earnings generated from interactive multimedia is set aside as loyalty credit. On a periodic basis, the loyalty credit is distributed to a number of users that are the most charitable. The distribution can occur using competitions, sweepstakes, etc.

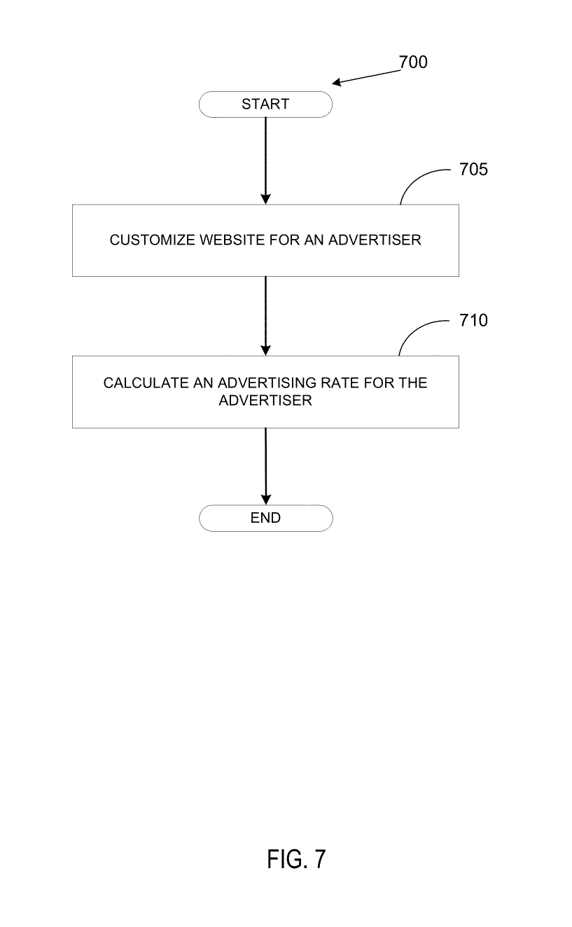

FIG. 7 is a flow diagram illustrating an embodiment for a method 700 of providing an advertiser benefit. The method 700 may be performed by processing logic that may include hardware (e.g., circuitry, dedicated logic, programmable logic, microcode, etc.), software (e.g., instructions run on a processing device to perform hardware simulation), or a combination thereof. In one embodiment, the method 700 is performed by a server (e.g., the advertisement system 110 of FIG. 1).

At block 705, processing logic can customize a website for an advertiser. The website can be associated with the advertiser as well as with interactive multimedia system that promotes social responsibility. Processing logic can customize the website to include information about the charitable causes supported by the advertiser. Moreover, processing logic can customize the website to include information about the products associated with the advertiser to encourage users to purchase the products because the advertiser is a socially responsible company. For example, if a company donates 10% of its profits to a charitable cause, the company can have a personalized website including this information, as well as all the products available for sale by the company.

At block 710, processing logic can determine an advertising rate for the advertiser. The advertising rate can be determined based on a discount that the advertiser is willing to offer to registered users. For example, if the advertiser offers a 5% discount on a product, processing logic determines that the advertiser should pay $0.01 per advertisement rather than $0.02 per advertisement. The advertising rate can further be determined or adjusted based on a donation that the advertiser is willing to make to a charitable cause. The charitable cause can be selected by the user, by an advertisement system, by the advertiser, etc. For example, if the advertiser donates $1,000 to a clean water charitable cause, processing logic determines that the advertiser should pay $0.01 per advertisement rather than $0.02 per advertisement. The advertising rate can further be determined or adjusted based on whether the advertiser encourages users to donate to a charitable cause. For example, if interactive multimedia created by the user includes a statement “Donate your change to help a charitable organization”, processing logic determines that the advertiser should pay $0.01 per advertisement rather than $0.02 per advertisement. Processing logic can determine the advertising rate by measuring and weighting the discount provided by the advertiser to users, the donation level of the advertiser, and whether the advertiser prompts users to donate to charitable causes. Processing logic can optionally determine a price scale that illustrates varying advertising rates based upon varying discounts, donations, and/or prompts. For example, the price scale can include a lower advertising rate if the advertiser donates $1,000 than if the advertiser donates $100. In some embodiments, advertisers may also bid for remnant advertising space, provide last minute offers, and bid to send interactive multimedia to one or more users.

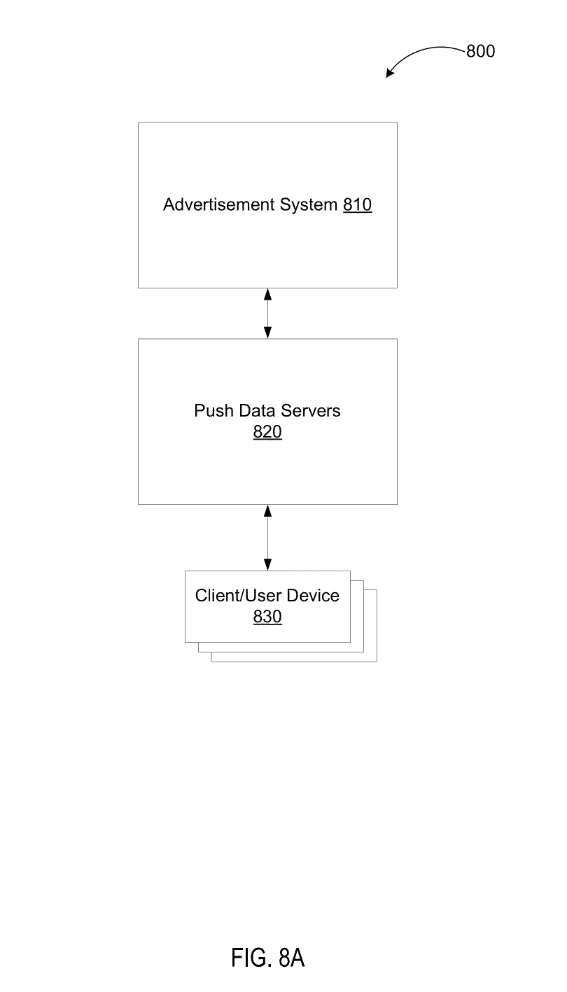

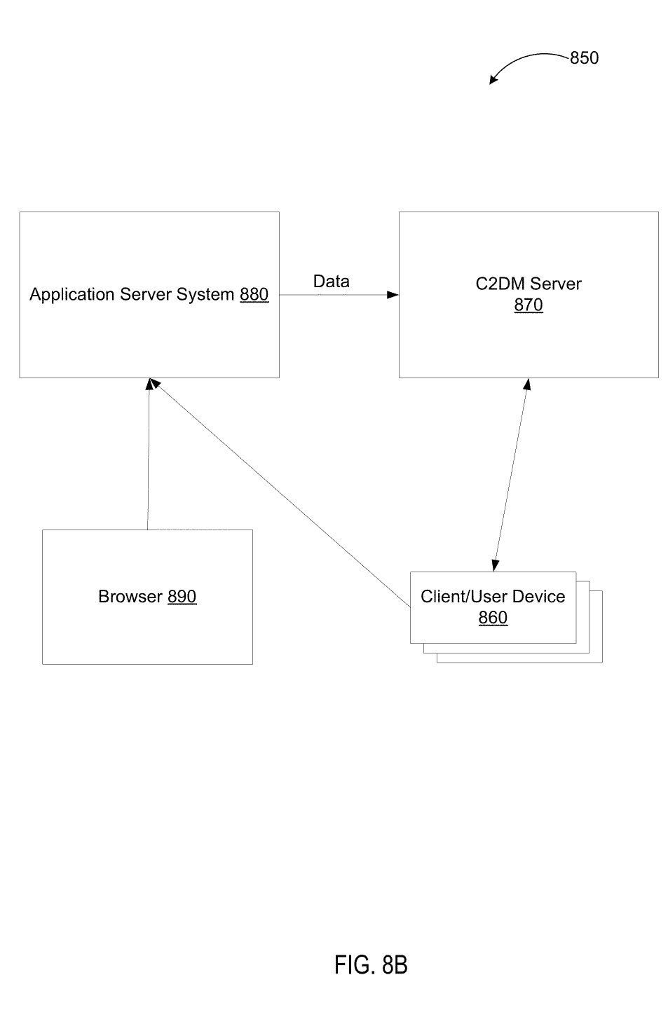

FIG. 8A provides an exemplary implementation for a push service 800. Communication between client/user devices 830 and the advertising system 810 may be carried in two ways, namely, push. Likewise, in a push function, using the mobile communications device's platform provider services (e.g., GOOGLE for ANDROID devices, RIM for BLACKBERRY devices), the push data servers 820 will be able to call the client/user device 830 in order to notify it about a campaign. This will be used for last-minute campaigns that may be sent at any moment and where waiting for the next sync is not an option.

FIG. 8B provides an exemplary implementation for a pull service 850. In a pull function, at a regular interval, mobile communications devices, such as client/user devices 860 call the C2DM server 870 and synchronize (i.e., they return the last campaign results and ask for the new campaign). The C2DM server 870 is called preferably using the HTTP protocol and exchanging JSON formatted content, using a REST interface. The C2DM server 870 will receive the request and return the proper response. In one embodiment, the response is received from the application server system 880. In an alternate embodiment, the client/user device 860 provides the request directly to the application server system 880. In some embodiments, a browser 890 can provide a request to the application server system 880. In some embodiments, a browser 890 provides interactive multimedia or other data to the application server system 880.

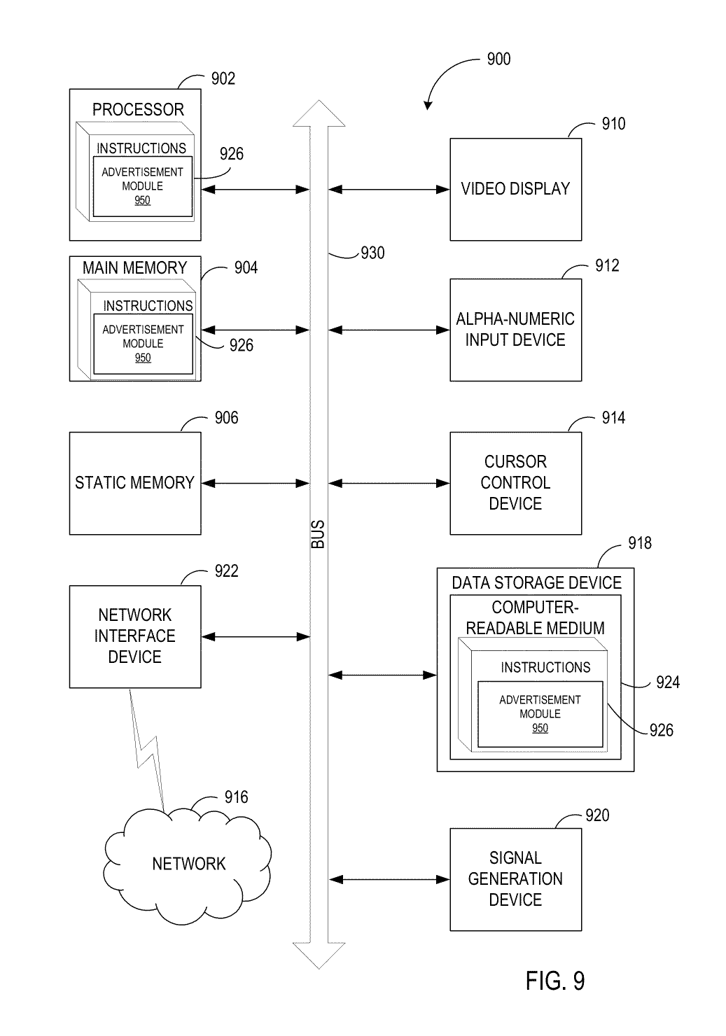

FIG. 9 illustrates a diagrammatic representation of a machine in the exemplary form of a computer system 900 within which a set of instructions, for causing the machine to perform any one or more of the methodologies discussed herein, may be executed. In alternative embodiments, the machine may be connected (e.g., networked) to other machines in a LAN, an intranet, an extranet, or the Internet. The machine may operate in the capacity of a server or a client machine in client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 900 includes a processing device (processor) 902, a main memory 904 (e.g., read-only memory (ROM), flash memory, dynamic random access memory (DRAM) such as synchronous DRAM (SDRAM) or Rambus DRAM (RDRAM), etc.), a static memory 906 (e.g., flash memory, static random access memory (SRAM), etc.), and a data storage device 918, which communicate with each other via a bus 530.

Processor 902 represents one or more general-purpose processing devices such as a microprocessor, central processing unit, or the like. More particularly, the processor 902 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 902 may also be one or more special-purpose processing devices such as an application specific integrated circuit (ASIC), a field programmable gate array (FPGA), a digital signal processor (DSP), network processor, or the like. The processor 902 is configured to execute instructions 926 for performing the operations and steps discussed herein.

The computer system 900 may further include a network interface device 922. The computer system 900 also may include a video display unit 910 (e.g., a liquid crystal display (LCD) or a cathode ray tube (CRT)), an alphanumeric input device 912 (e.g., a keyboard), a cursor control device 914 (e.g., a mouse), and a signal generation device 920 (e.g., a speaker).

The data storage device 918 may include a computer-readable storage medium 924 on which is stored one or more sets of instructions 926 (e.g., software) embodying any one or more of the methodologies or functions described herein. The instructions 926 may also reside, completely or at least partially, within the main memory 904 and/or within the processor 902 during execution thereof by the computer system 900, the main memory 904 and the processor 902 also constituting computer-readable storage media. The instructions 926 may further be transmitted or received over a network 916 via the network interface device 922.

In one embodiment, the instructions 926 include instructions for an advertisement module 950, which may correspond to advertising module 114 of FIG. 1, and/or a software library containing methods that provide interactive multimedia to computing devices. While the computer-readable storage medium 924 is shown in an exemplary embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

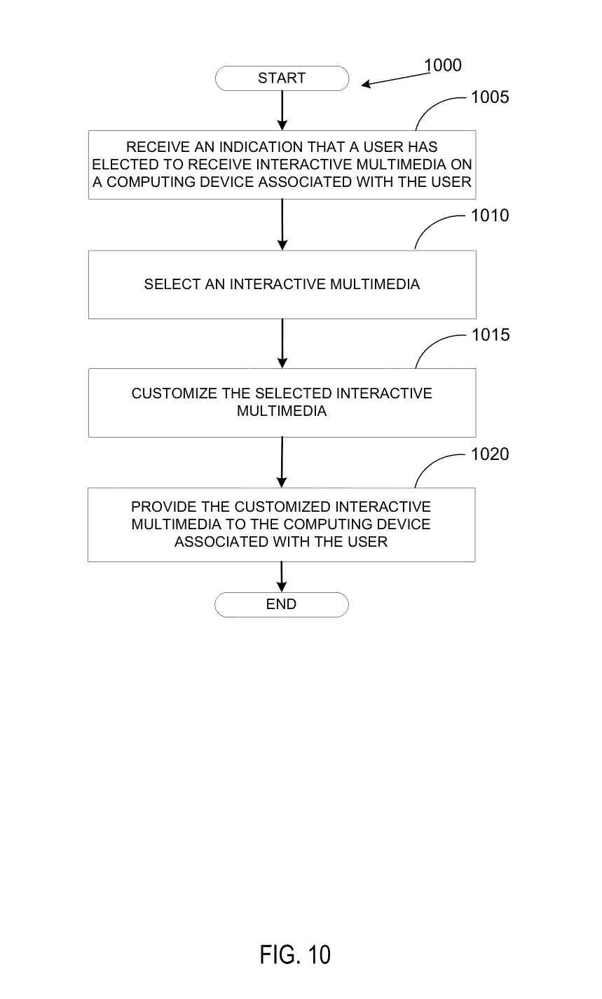

FIG. 10 is a flow diagram illustrating an embodiment for a method 1000 of directing interactive multimedia to computing devices. The method 1000 may be performed by processing logic that may include hardware (e.g., circuitry, dedicated logic, programmable logic, microcode, etc.), software (e.g., instructions run on a processing device to perform hardware simulation), or a combination thereof. In one embodiment, the method 1000 is performed by a server (e.g., the advertisement system 110 of FIG. 1).

At block 1005, processing logic receives an indication that a user has elected to receive interactive multimedia on a computing device associated with the user (e.g., as can be received via an interaction with one or more of the referenced advertisements by the user). In one embodiment, processing logic receives an indication that the user has elected to receive interactive multimedia when the user requests interactive multimedia using a computing device associated with the user, such as a mobile device associated with the user, a computer associated with the user, etc. For example, the user requests interactive multimedia from his mobile phone when going to lunch in order to receive interactive multimedia for a nearby restaurant.

In an alternate embodiment, processing logic receives an indication that the user has elected to receive interactive multimedia on a periodic basis, such as hourly, weekly, etc. The periodic basis can be defined by an advertising system, by the user, etc. For example, the user indicates in a user profile or user preferences that the user would like to receive interactive multimedia on a daily basis.

In another alternate embodiment, processing logic receives an indication that the user has elected to receive interactive multimedia when the user provides a registration of the user to receive interactive multimedia. In one such embodiment, the user registers to receive interactive multimedia by installing an application on a computing device and registering with the application. In one embodiment, the user registers directly with the application by providing an identification of the user (e.g., full name, user name, etc.), an email address, and a password. In response, the application can send an email to the email address provided by the user and the user can verify that the user received the email. In an alternate embodiment, the user registers indirectly with the application using a third party account, such as a social media account (e.g., Google®, Facebook®, Twitter®, etc.). In this embodiment, the user registers indirectly by providing the user's login information for the third party account.

As part of the registration process, the user can create a user profile. The user profile can include information about the user, such as a geographic location for the user (e.g., country, city, address, etc.), important dates for the user (e.g., the user's birthday, the user's anniversary, the user's spouse's birthday, religious holidays, non-religious holidays, etc.), brands that the user likes and/or dislikes, interests of the user, hobbies of the user, food/cuisines enjoyed by the user, property owned or used by the user (e.g., the make, model, and year of the car driven by the user, that the user owns a home, etc.), and other personal information about the user that can be used by processing logic to determine interactive multimedia to provide to the user. The user profile can further include preferences of the user, such as an amount of time that the user is willing to be exposed to interactive multimedia (e.g., 2 hours, 1 week, etc.), a period of time that the user is willing to be exposed to interactive multimedia (e.g., day, night, etc.), etc.

At block 1010, processing logic selects an interactive multimedia (e.g., an offer description, video, discount code, audio jingle, etc.) to provide to a user based on the user profile associated with the user. The interactive multimedia can be created by an advertiser. It should also be noted that, in certain implementations, such interactive multimedia can be created by one user and directed/provided to another user, e.g., in a scenario in which one user utilizes the interactive ad space to send a personalized greeting, gift, etc., to another user or users.

In some embodiments, processing logic can select the interactive multimedia to provide to a user based on an auction. In these embodiments, the interactive multimedia can be offered on an auction basis, allowing advertisers to bid to be able to provide the interactive multimedia to the user. For example, interactive multimedia that is date specific, such as interactive multimedia directed to a user on the user's birthday or on particular holiday, may be offered to multiple advertisers to bid on, with the winning bidder being offered the opportunity to provide interactive multimedia to the user for an exclusive, limited period of time.

In some embodiments, multiple advertisers may wish to provide the same advertising impressions (e.g., offers that are provided to a specific user on a date of interest to that user, whether a specific holiday, a birthday, an anniversary, or the like). However, in order not to overload the user with a large number of interactive multimedia sharing such impression, processing logic can limit the number of advertisers that may use such an impression in a single instance. If more than one advertiser has opportunity to provide interactive multimedia to a user that makes up such an impression (such as by multiple advertisers having purchased such particular advertising impression that meets certain demographic and behavioral fields), and such impression is not available (e.g., one advertiser has already used such impression for a specific instance, such as the user's birthday), processing logic can determine to wait until the next available slot that meets those demographic and/or behavioral fields becomes available, and provide that instance to the next advertiser that has purchased the same impression to select as the interactive multimedia to the user.

In one embodiment, processing logic selects the interactive multimedia based on the user profile associated with the user. Processing logic can select the interactive multimedia by selecting an active advertisement that best matches the information in the user profile. An interactive multimedia is active if an account balance associated with the interactive multimedia has one or more credits. The advertiser that created the account can purchase credits for the advertiser or for the interactive multimedia. In one embodiment, processing logic selects the interactive multimedia based on the user profile associated with the user and other external information, such as a current geographic location of the user (e.g., obtained using a Global Positioning System, etc.), the current date (e.g., obtained from a system clock of the computing device, from an external system, etc.). For example, a user profile includes information that the user lives in France and enjoys German cuisine, has a current geographic location in England, and there are two interactive multimedia available, the first advertisement for an Italian restaurant in France and the second advertisement for a German restaurant in England. In this example, using the current geographic location of England for the user as well as the user preference for German food, processing logic determines the interactive multimedia that is customized to the user as the second advertisement (German restaurant in England). In another example, processing logic determine from the user profile that the user's anniversary is in 2 days and selects interactive multimedia for a local jewelry store to provide to the user. In another example, external information indicates that the current date is Valentine's Day, the user profile includes information that the user is married, and the user's current geographic location is near a florist and a drugstore. In this example, there are two interactive multimedia: interactive multimedia for Valentine's Day flowers from the florist and interactive multimedia for over-the-counter medication from the drugstore. In this example, processing logic processes the information that the user is married and it is Valentine's Day, and selects the interactive multimedia for Valentine's Day flowers from the florist. However, in this example, if the user profile further indicates that the user is boycotting the florist because of bad business practices, processing logic will select the interactive multimedia for the drugstore.

Additionally, in certain implementations the technologies described herein can be configured to ‘learn’ from the user's behavior and interaction with the interactive content sent (ads, news, etc.). Such technologies can, for example, enable the system to learn from the referenced user behavior in order to provide appropriate/suitable advertisements, news, and/or content, e.g., at the wallpaper and/or lock-screen space. It should also be noted that such interactions can be used to automatically build a user profile that can be subsequently used to better target the ads.

In an alternate embodiment, the selected interactive multimedia is one or more campaigns. Each campaign can include a start date and time, an end date and time, and campaign information. The campaign information can include information specific to the campaign, such as an identifier (e.g., name) of the campaign, a description of the campaign, a type of the campaign associated with an objective (e.g., wallpaper, wallpaper and ringtone, ringtone, last minute, birthdate, default, etc.), and data associated with the type of the campaign. For example, a wallpaper campaign for “Tow Truck Company A” can start today and end a week from today. In this example, the data associated with the campaign includes the wallpaper associated with Tow Truck Company A to be provided to computing devices and displayed as the wallpaper on the computing devices of users receiving the campaign. In another example, if the type of the campaign is a wallpaper and ringtone campaign, the data associated with the campaign will include the wallpaper and ringtone to be provided to the computing devices of users receiving the campaign.

At block 1015, processing logic customizes the selected interactive multimedia. In one embodiment, processing logic customizes the selected interactive multimedia by including a personalized message specifically directed to the user of the computing device. The personalized message can be a pop-up message, desktop background, a wallpaper, a customized audio file, etc., that the user can consume (view, hear, etc.) when interacting with the computing device associated with the user. The personalized message can be interactive to allow the user to interact with the personalized message, with the interactive multimedia, or with a website associated with the interactive multimedia. For example, the user profile of user John Smith indicates that it is John's twenty-fifth birthday and processing logic selects interactive multimedia for a beverage. In this example, processing logic customizes the interactive multimedia by including a personalized message stating “Hello John Smith. The XYZ Cola Company wishes you a very happy 25^{th} birthday! Please go to our website and find your special birthday gift waiting for you!” In this example, the interactive multimedia is specifically formatted for the intended user (delivered on the user's actual 25^{th} birthday), and is interactive, allowing the user to engage a link (“website” in the above message) which may navigate the user to the related product or advertiser's website. The product or advertiser's website may, in turn, provide a coupon for use by the user either on an online purchase or alternatively for offline use, such as by simply displaying the coupon on the computing device to a retailer that accepts such coupons.

In one embodiment, processing logic customizes the selected interactive multimedia based on interactive multimedia that were previously successful for the user. Processing logic can use a record of the user's interactions with previous interactive multimedia to select the interactive multimedia that were previously successful.

In one embodiment, processing logic customizes the selected interactive multimedia based on a user incentive amount associated with the user. For example, a user that has a large user incentive amount can receive a better or higher value offer, a larger discount, etc. than a user who has a smaller user incentive amount. Likewise, the campaign may be customized so that very high value offers may be reserved for and presented only to users whose profile maintains a certain minimum number of points that may be designated by the advertising content provider. Still further, the campaign may be customized to provide a campaign in which the value of a specific offer is determined by each user's level of donations, such as the total dollar value of cash donations made by each user, to certain charitable causes. In this case, the causes may optionally be causes that are voted on by a number of users of the system as socially important, and the offer value may be further dependent upon the votes that have been cast for the cause to which the user has made a donation. Further, the offer value may be further customized to depend upon the total level or economic value of the user's donation.

In one embodiment, processing logic can customize the selected interactive multimedia to include advertisement content, a display time range for the interactive multimedia, and a value for each display time range that can be provided to the user in exchange for the user's agreement to have the interactive multimedia display on a computing device of the user. Processing logic can further customize the selected interactive multimedia to include a specific hour span or date for display of the interactive multimedia selected by the user, such as only at particular times of the day or night, on dates of particular relevance, at particular dates of significant interest (e.g., Christmas), etc.

At block 1020, processing logic provides the interactive multimedia to a computing device associated with the user. In this embodiment, processing logic can configure the interactive multimedia to a computing device associated with the user, such that the interactive multimedia can be properly displayed on a user interface of the device. Processing logic can provide the interactive multimedia to the user by transmitting information to the computing device associated with the user. For example, processing logic can transmit the information as a data packet in the form of a message, notification, or the like particularly configured for the platform on which the computing device associated with the user is operating. The information can include the interactive multimedia (e.g., new wallpaper, ringtone, etc.), and an executable instruction that causes the computing device to update the user interface on the computing device to ensure that the interactive multimedia is presented to the user as intended. The information can include an instruction causing the computing device to change a portion (e.g., wallpaper, ringtone, etc.) of the computing device to include the interactive multimedia. For example, if the interactive multimedia is to be displayed on the wallpaper of the computing device as an ad for Tow Truck Company A, processing logic transmits the interactive multimedia for Tow Truck Company A and an instruction to change the wallpaper of the computing device. In this example, upon receiving the instruction and the interactive multimedia, the computing device of the user will execute the instruction and change the wallpaper of the computing device to include the interactive multimedia for Tow Truck Company A. In one embodiment, the computing device of the user will execute the instruction and change the wallpaper of the computing device only when the user is logged in or has otherwise provided information indicating that the user would like to have the wallpaper of the computing device changed.

Upon receiving the instruction and the interactive multimedia, the computing device associated with the user can lock the portion of the computing device that includes the interactive multimedia for a predefined amount of time. The predefined amount of time can be defined by the user preferences associated with the user, by the advertiser associated with the interactive multimedia, by an advertisement system, etc.

When the interactive multimedia has been delivered to the user's computing device, the use can consume (e.g., view, watch, listen, etc.) the interactive multimedia. The computing device can present the user with interactive options, such as saving the interactive multimedia to a list of “favorites” for future use; resending interactive multimedia or discount offer to friends or contacts, such as friends or contacts within the user's online social network community; electronically navigating to the advertiser's website; viewing a video advertisement provided by the advertiser; engage the advertiser's electronic, online ordering system to make a purchase; etc. Processing logic can maintains a record of the user's interaction with each advertisement that is sent to a computing device associated with the user. For example, processing logic can record when the user viewed interactive multimedia, when the user engaged links in interactive multimedia, when the user made a purchase after receiving interactive multimedia, when the user declined a purchase after receiving interactive multimedia, etc. Based upon the record of the user's interaction with the interactive multimedia, processing logic can customize future interactive multimedia to take advantage of interactive multimedia that are most successful (based on the particular interactions the user had with a given advertisement).

When the selected interactive multimedia associated with the advertiser or the interactive multimedia is provided to a user, the number of credits in the account balance associated with the interactive multimedia is decremented. For example, if the account balance associated with interactive multimedia is 10 and the interactive multimedia is provided to 2 users, the account balance associated with the interactive multimedia will be decremented by 2, leaving an account balance of 8. Processing logic can compare the active interactive multimedia to the information in the user profile and select the active advertisement that most closely meets the information in the user profile. For example, a user profile includes information that the user lives in France and enjoys German cuisine, and there are two interactive multimedia available, the first advertisement for an Italian restaurant in France and the second advertisement for a German restaurant in England. In this example, processing logic selects the interactive multimedia for the Italian restaurant in France, as it is unlikely that the user will want to travel to England to eat at the German restaurant.

In the foregoing description, numerous details are set forth. It will be apparent, however, to one of ordinary skill in the art having the benefit of this disclosure, that the present disclosure may be practiced without these specific details. In some instances, well-known structures and devices are shown in block diagram form, rather than in detail, in order to avoid obscuring the present disclosure.

Some portions of the detailed description have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “determining”, “computing”, “calculating”, “obtaining”, “identifying”, “presenting,” “receiving,” “modifying”, or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

The present disclosure also relates to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

Reference throughout this specification to “one embodiment” or “an embodiment” means that a particular feature, structure, or characteristic described in connection with the embodiment is included in at least one embodiment. Thus, the appearances of the phrase “in one embodiment” or “in an embodiment” in various places throughout this specification are not necessarily all referring to the same embodiment. In addition, the term “or” is intended to mean an inclusive “or” rather than an exclusive “or.”

It is to be understood that the above description is intended to be illustrative, and not restrictive. Many other embodiments will be apparent to those of skill in the art upon reading and understanding the above description. The scope of the disclosure should, therefore, be determined with reference to the appended claims, along with the full scope of equivalents to which such claims are entitled.

We claim:

1. A method comprising:
receiving, by a processing device, an indication that a user has elected to receive interactive multimedia on a computing device associated with the user;
selecting an interactive multimedia to provide to the user;
customizing the selected interactive multimedia; and
providing the customized interactive multimedia to the computing device associated with the user, wherein providing the customized interactive multimedia to the computing device causes the customized interactive multimedia to be consumed by the user.

2. The method of claim 1, further comprising:
calculating a donation amount to donate to a charitable cause based on revenue generated by the customized interactive multimedia;
determining a user incentive for the user based on the revenue generated by the customized interactive multimedia;
determining whether the user donated a portion of the user incentive;
upon determining that the user donated a portion of the user incentive, calculating a loyalty credit to provide to the user based on the portion of the user incentive, wherein the loyalty credit is associated with a loyalty program that rewards the user for a charitable action; and
upon determining that the user did not donate a portion of the user incentive, retaining the user incentive with respect to the user.

3. The method of claim 1, wherein the customized interactive multimedia comprises at least one of a computing device wallpaper customized for an advertiser associated with the selected interactive multimedia, a computing device ringtone customized for the advertiser associated with the selected interactive multimedia, an audio file customized for the advertiser associated with the selected interactive multimedia, or a computing device screen saver customized for the advertiser associated with the selected interactive multimedia.

4. The method of claim 1, wherein selecting the interactive multimedia to provide to the user is further based on a geographic location of the user.

5. The method of claim 2, further comprising:
calculating a content usage of the customized interactive multimedia for the user, wherein the donation amount is calculated based on the content usage of the customized interactive multimedia, and wherein the user incentive is calculated based on the content usage of the customized interactive multimedia.

6. The method of claim 5, wherein calculating the content usage comprises:
for each time interval of a plurality of time intervals, determining whether an objective associated with the customized interactive multimedia is met; and
calculating the content usage as a ratio of a number of time intervals that the objective associated the customized interactive multimedia is met and a total number of the plurality of time intervals.

7. The method of claim 2, wherein the donation amount is calculated as a predefined percentage of the revenue and the user incentive is calculated as the predefined percentage of the revenue.

8. The method of claim 2, further comprising:
calculating an additional user credit upon receiving an indication that the user has purchased a product associated with a socially responsible company.

9. The method of claim 1, further comprising:
customizing a website for an advertiser associated with the customized interactive multimedia; and
calculating an advertising discount for the advertiser based on a charitable amount donated by the advertiser.

10. The method of claim 2, wherein the loyalty program rewards the user by providing a discount to the user based on the loyalty credit.

11. The method of claim 2, wherein the loyalty program rewards the user by recognizing the user in a public manner if the user has a greater amount of loyalty credit compared to other users in the loyalty program.

12. A non-transitory computer readable storage medium having instructions that, when executed by a processing device, cause the processing device to perform operations comprising:
receiving, by the processing device, an indication that a user has elected to receive interactive multimedia on a computing device associated with the user;
selecting an interactive multimedia to provide to the user;
customizing the selected interactive multimedia; and
providing the customized interactive multimedia to the computing device associated with the user, wherein providing the customized interactive multimedia to the computing device causes the customized interactive multimedia to be consumed by the user.

13. The non-transitory computer readable storage medium of claim 12, wherein the instructions, when executed by the processing device, cause the processing device to perform further operations comprising:
calculating a donation amount to donate to a charitable cause based on revenue generated by the customized interactive multimedia;
determining a user incentive for the user based on the revenue generated by the customized interactive multimedia;
determining whether the user donated a portion of the user incentive;
upon determining that the user donated a portion of the user incentive, calculating a loyalty credit to provide to the user based on the portion of the user incentive, wherein the loyalty credit is associated with a loyalty program that rewards the user for a charitable action; and
upon determining that the user did not donate a portion of the user incentive, providing the user incentive to the user.

14. The non-transitory computer readable storage medium of claim 12, wherein the customized interactive multimedia comprises at least one of a computing device wallpaper customized for an advertiser associated with the selected interactive multimedia, a computing device ringtone customized for the advertiser associated with the selected interactive multimedia, an audio file customized for the advertiser associated with the selected interactive multimedia, or a computing device screen saver customized for the advertiser associated with the selected interactive multimedia.

15. The non-transitory computer readable storage medium of claim 13, wherein the instructions, when executed by the processing device, cause the processing device to perform further operations comprising:
calculating a content usage of the customized interactive multimedia for the user, wherein the donation amount is calculated based on the content usage of the customized interactive multimedia, and wherein the user incentive is calculated based on the content usage of the customized interactive multimedia.

16. The non-transitory computer readable storage medium of claim 12, wherein the instructions, when executed by the processing device, cause the processing device to perform further operations comprising:
customizing a website for an advertiser associated with the customized interactive multimedia; and
calculating an advertising discount for the advertiser based on a charitable amount donated by the advertiser.

17. A computing device comprising:
a memory; and
a processing device coupled to the memory, wherein the processing device is to:
receive an indication that a user has elected to receive interactive multimedia on a computing device associated with the user;
select an interactive multimedia to provide to the user;
customize the selected interactive multimedia; and
provide the customized interactive multimedia to the computing device associated with the user, wherein providing the customized interactive multimedia to the computing device causes the customized interactive multimedia to be consumed by the user.

18. The computing device of claim 17, wherein the processing device is further to:
calculate a donation amount to donate to a charitable cause based on revenue generated by the customized interactive multimedia;
determine a user incentive for the user based on the revenue generated by the customized interactive multimedia;
determine whether the user donated a portion of the user incentive;
upon determining that the user donated a portion of the user incentive, calculate a loyalty credit to provide to the user based on the portion of the user incentive, wherein the loyalty credit is associated with a loyalty program that rewards the user for a charitable action; and
upon determining that the user did not donate a portion of the user incentive, provide the user incentive to the user.

19. The computing device of claim 18, wherein the donation amount is calculated as a predefined percentage of the revenue and the user incentive is calculated as the predefined percentage of the revenue.

20. The computing device of claim 17, wherein the customized interactive multimedia comprises at least one of a computing device wallpaper customized for an advertiser associated with the selected interactive multimedia, a computing device ringtone customized for the advertiser associated with the selected interactive multimedia, an audio file customized for the advertiser associated with the selected interactive multimedia, or a computing device screen saver customized for the advertiser associated with the selected interactive multimedia.
